(19) United States
(12) Patent Application Publication
(10) Pub. No.: US 2004/0072680 A1
(43) Pub. Date: Apr. 15, 2004

(54) Chiral phosphorus cyclic compounds for transition metal-catalyzed asymmetric reactions

(75) Inventor: Xumu Zhang, State College, PA (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: THE PENN STATE RESEARCH FOUNDATION

(21) Appl. No.: 10/423,485

(22) Filed: Apr. 25, 2003

Related U.S. Application Data
(60) Provisional application No. 60/377,105, filed on Apr. 26, 2002.

(51) Int. Cl. B01J 31/00; C07F 9/02

(52) U.S. Cl. 502/150; 502/155; 556/21; 568/12

(57) ABSTRACT

Chiral phospholanes having biaryl chirality for applications in asymmetric catalysis are provided. A series of new chiral mono- or bidentate phosphorus ligands were efficiently prepared through a key intermediate (S)-4-chloro-4,5-dihydro-3H-4-phospha-cyclohepta[2,1-a;3,4-a′]binaphthalene and its derivatives. These ligands were complexed with transition metals to prepare catalysts, which were used in asymmetric catalytic reactions, such as, asymmetric hydrogenation, hydride transfer, allylic alkylation, hydrosilylation, hydroboration, hydrovinylation, hydroformylation, olefin metathesis, hydrocarboxylation, isomerization, cyclopropanation, Diels-Alder reaction, Heck reaction, isomerization, Aldol reaction, Michael addition; epoxidation, kinetic resolution or [m+n] cycloaddition wherein m=3 to 6 and n=2.

This application claims priority from U.S. Provisional Application Serial No. 60/377,105, filed Apr. 26, 2002.

### BACKGROUND OF THE INVENTION

1. Field of the Invention

The invention relates to transition metal-catalyzed asymmetric ligands, catalysts prepared therefrom and the reactions of the catalysts. In particular, the invention relates to novel biaryl phospholane ligands, catalysts derived therefrom, and their use in asymmetric catalysis.

2. Description of the Prior Art

Discovery of new chiral phosphorus ligands plays a critical role in asymmetric catalysis. Atropisomeric 1,1′-binaphthalene core is the parent framework of steadily increasing families of chiral ligands for asymmetric reactions. Researchers (M. Reetz & P. Pringle) have prepared chelating chiral phosphites using readily accessible Binaphthol (BINOL) as the starting material and demonstrated that they are excellent ligands for Rh-catalyzed asymmetric hydrogenation of dehydroamino acids.

Feringa has developed a variety of chiral phosphoramidites from BINOL and high enantioselectivities (up to 98% ee) were achieved in Michael addition of cyclic enones.

Gladiali has made several mono- or bidentate chiral phosphanes as well as the corresponding racemic chelating derivatives bearing the 1,1′-binaphthyl core. However, only limited applications of these ligands for asymmetric catalysis have been reported. Additionally, a group including the present inventor has prepared a couple of binaphthyl derived phosphine type ligands that are very effective for asymmetric catalysis (Xiao, D.; Zhang, Z.; Zhang, X. Org. Lett. 1999, 1, 1679; Xiao, D.; Zhang, X. Angew. Chem., Int. Ed. 2001, 40, 3425).

Despite these advances, there continues to be a need for improved ligands for asymmetric catalysis and those based on a 1,1′ binaphthyl core are especially attractive. This is the need addressed by the present invention.

### SUMMARY OF THE INVENTION

The present invention provides chiral phospholane ligands that have utility in asymmetric catalysis. The chiral ligands include compounds represented by the following formulas and its enantiomer:

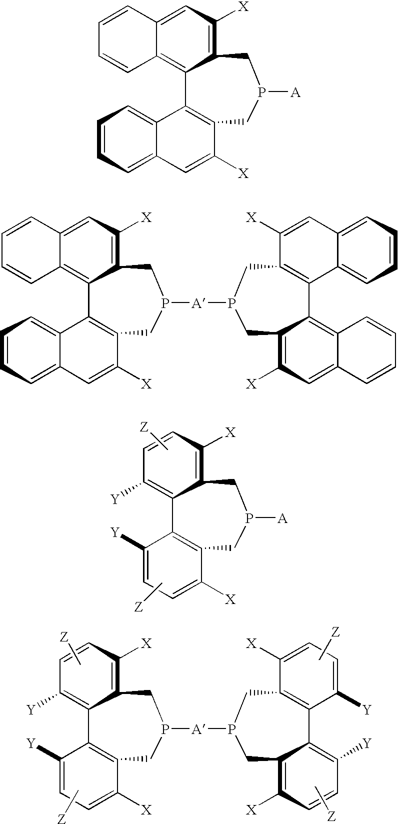

wherein each R and R′ can independently be alkyl, aryl, alkylaryl, arylalkyl, each of which can be independently substituted with one or more groups can be carboxylic acid, alkoxy, hydroxy, alkylthio, thiol or dialkylamino groups;

wherein each X can independently be hydrogen, halide, alkyl, aryl, alkylaryl, arylalkyl, alkoxy, silane, carboxylate or amide;

wherein each Y can independently be alkyl, aryl, alkylaryl, arylalkyl, alkoxy, carboxylic, amide or a heterocyclic compound;

wherein each Z can independently be hydrogen, alkyl, aryl, alkylaryl, arylalkyl, alkoxy, amide, carboxylate, or a heterocyclic compound;

wherein A can be halide, alkoxy, phenoxide, amide or substituted amide;

wherein A′ can be, —OR²O—, —NHR²NH—, NR′(R²)NR′—, —NR′—, ferrocene or a chemical bond; and

wherein R² can be an alkylene, arylene or heteroarylene group.

The present invention further provides a catalyst prepared by a process including:

contacting a transition metal salt, or a complex thereof, and a chiral ligand according to the present invention, wherein the contacting is carried out under conditions to produce the catalyst.

The present invention still further provides a process for preparation of an asymmetric compound. The process includes the step of:

contacting a substrate capable of forming an asymmetric product by an asymmetric reaction and a catalyst under conditions to produce the asymmetric compound; wherein the catalyst is prepared by a process including contacting a transition metal salt, or a complex thereof, and a chiral ligand according to the present invention.

The present invention also provides a process for the preparation of 4-halo-4,5-dihydro-3H-4-phospha-cyclohepta[2,1-a;3,4-a′] binaphthalene. The process includes:

contacting di-lithium complex of 2,2′-dimethyl-1,1′-binaphthyl and PX₃ under reaction conditions sufficient to produce the 4-halo-4,5-dihydro-3H-4-phospha-cyclohepta[2,1-a;3,4-a′] binaphthalene; wherein X can be Cl, Br or I.

The present invention further provides a process for the preparation of a chiral bisphosphine ligand, including the step of:

contacting (R) or (S)-4-halo-4,5-dihydro-3H-4-phospha-cyclohepta[2,1-a;3,4-a′]binaphthalene and a reagent, such as, LiA′Li and XMgA′MgX wherein X is Cl or Br; wherein A′ can be —OR²O—, —NH R²NH—, NR′(R)NR′—, —NR′—, ferrocene or a chemical bond; and wherein R² can be an alkylene, arylene or heteroarylene group;

wherein the contacting is carried out under conditions to produce the chiral bisphosphine ligand.

The present invention still further provides a process for the preparation of a chiral phospholane having a ferrocene backbone. The process includes:

contacting di-lithium complex of 2,2′-dimethyl-1,1′-binaphthyl and Cl₂P(CpFeCp)PCl₂ under reaction conditions sufficient to produce the chiral phospholane having a ferrocene backbone.

The present invention further still provides a process for the preparation of a chiral bisphosphine ligand. The process includes the step of:

contacting, in the presence of a base, (R) or (S)-4-halo-4,5-dihydro-3H-4-phospha-cyclohepta[2,1-a;3,4-a′]-binaphthalene and NH2R′, HOR²OH, NH2-R²NH2 and HNR′(R²)NR′H; wherein R² can be an alkylene, arylene or heteroarylene group; and wherein each R and R′ can independently be alkyl, aryl, alkylaryl or arylalkyl, each of which can be independently substituted with one or more groups, such as, carboxylic acid, alkoxy, hydroxy, alkylthio, thiol or dialkylamino groups.

### DETAILED DESCRIPTION OF THE INVENTION

The present invention provides novel chiral phospholanes for applications in asymmetric catalysis. An array of new phospholanes having biaryl chirality was prepared. A series of new chiral mono- or bi-dentate phosphorus ligands were efficiently prepared through a key intermediate (S)-4-chloro-4,5-dihydro-3H-4-phospha-cyclohepta[2,1-a; 3,4-a′]binaphthalene and its derivatives. These ligands were complexed with transition metals and applied in asymmetric catalytic reactions.

The ligands of the invention have the following structures along with their corresponding enantiomers:

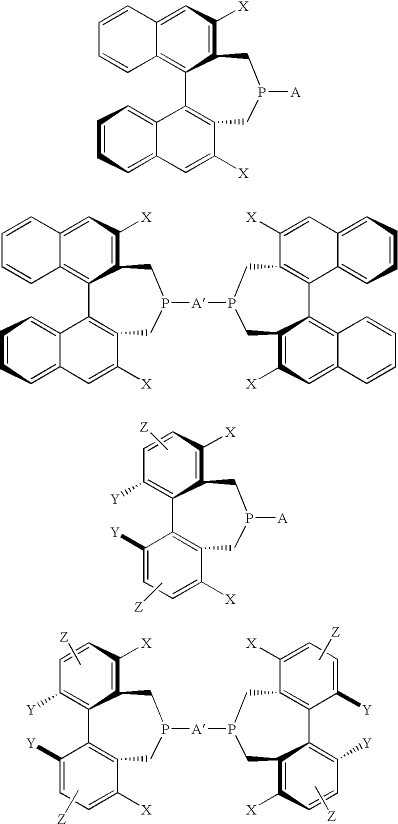

In these structures, each R and R′ can independently be alkyl, aryl, alkylaryl, arylalkyl, each of which can be independently substituted with one or more groups, such as, carboxylic acid, alkoxy, hydroxy, alkylthio, thiol, and dialkylamino groups;

wherein each X can independently be hydrogen, halide, alkyl, aryl, alkylaryl, arylalkyl, alkoxy, silane, carboxylate and amide;

wherein each Y can independently be alkyl, aryl, alkylaryl, arylalkyl, alkoxy, carboxylic, amide and a heterocyclic compound;

wherein each Z can independently be hydrogen, alkyl, aryl, alkylaryl, arylalkyl, alkoxy, amide, carboxylate, and a heterocyclic compound;

wherein A can be halide, alkoxy, phenoxide, amide or substituted amide;

wherein A′ can be, —OR²O—, —NHR²NH—, NR′(R²)NR′—, —NR′—, ferrocene or a chemical bond; and

wherein R² can be an alkylene, arylene or heteroarylene group.

Each R and R′ group can further include a stereogenic center.

The present invention provides a simple and efficient synthetic pathway for making chiral phosphorus ligands. Using (S)-2,2′-dimethyl-1,1′-binaphthyl and it's 3,3′-diphenyl derivative, an array of new chiral mono- or bidentate phosphorus ligands were efficiently synthesized through a dilithiated binaphthyl species and (S)-4-chloro-4,5-dihydro-3H-4-phospha-cyclohepta[2,1-a;3,4-a] binaphthalene.

The key synthon for the synthesis of a variety of phosphorus ligands is (S)-4-chloro-4,5-dihydro-3H-4-phospha-cyclohepta[2,1-a;3,4-a′] binaphthalene, which can be prepared efficiently as follows:

The starting material, (S)-2,2′-dimethyl-1,1′-binaphthyl, is easily prepared through a two-step operation from (S)-BINOL according to recent literature methods (Ooi, T.; Kameda, M.; Maruoka, K. J. Am. Chem. Soc. 1999, 121, 6519). (S)-3,3′-Diphenyl-2,2′-dimethyl-1,1′-binaphthyl was prepared by the method of Maruoka. 2,2′-Dimethyl-1,1′-binaphthyl was lithiated with 2.5 equivalents of n-butyllithium in ether and the dilithium salt was separated under N₂ as red powder in 60% yield (Klein, H.; Jackstell, R.; Wiese, K.-D.; Borgmann, C.; Buller, M. Angew. Chem., Int. Ed. 2001, 40, 3408). Reaction of the dilithium salt with phosphine trichloride in hexane at r.t. overnight, followed by recrystallization from produces 4-chloro-4,5-dihydro-3H-4-phospha-cyclohepta[2,1-a;3,4-a] binaphthalene as the key synthon.

The present invention further provides a catalyst prepared by a process, which includes:

contacting a transition metal salt, or a complex thereof, and a chiral ligand according to the present invention as described herein above.

Suitable transition metals for the preparation of the catalyst include Ag, Pt, Pd, Rh, Ru, Ir, Cu, Ni, Mo, Ti, V, Re and Mn.

As mentioned above, the catalyst can be prepared by contacting a transition metal salt, or its complex, and a ligand according to the present invention.

Suitable transition metal salts or complexes include the following: AgX; Ag(OTf); Ag(OTf)₂; AgOAc; PtCl₂; H₂PtCl₄; Pd₂(DBA)₃; Pd(OAc)₂; PdCl₂(RCN)₂; (Pd(allyl)Cl)₂; Pd(PR₃)₄; (Rh(NBD)₂)X; (Rh (NBD)Cl)₂; (Rh(COD)Cl)₂; (Rh(COD)₂)X; Rh(acac)(CO)₂; Rh(ethylene)₂(acac); (Rh(ethylene)₂Cl)₂; RhCl(PPh₃)₃; Rh(CO)₂Cl₂; RuHX(L)₂(diphosphine), RuX₂(L)₂ (diphosphine), Ru(arene)X₂(di-phosphine), Ru(aryl group)X₂; Ru(RCOO)₂(diphosphine); Ru(methallyl)₂(diphosphine); Ru(aryl group)X₂(PPh₃)₃; Ru(COD)(COT); Ru(COD)(COT)X; RuX₂(cymen); Ru(COD)ₙ; Ru(aryl group)X₂(di-phosphine); RuCl₂(COD); (Ru(COD)₂)X; RuX₂(diphosphine); RuCl₂(═CHR)(PR₁₃)₂; Ru(ArH)Cl₂; Ru(COD)(methallyl)₂; (Ir (NBD)₂Cl)₂; (Ir(NBD)₂)X; (Ir(COD)₂Cl)₂; (Ir(COD)₂)X; CuX (NCCH₃)₄; Cu(OTf); Cu(OTf)₂; Cu(Ar)X; CuX; Ni(acac)₂; NiX₂; (Ni(allyl)X)₂; Ni(COD)₂; MoO₂(acac)₂; Ti(OiPr)₄; VO(acac)₂; MeReO₃; MnX₂ and Mn(acac)₂.

Each R and R′ in these ligands can independently be alkyl or aryl; Ar is an aryl group; and X is a counteranion.

In the above transition metal salts and complexes, L is a solvent and the counteranion X can be halogen, BF₄, B(Ar)₄ wherein Ar is fluorophenyl or 3,5-di-trifluoromethyl-1-phenyl, ClO₄, SbF₆, PF₆, CF₃SO₃, RCOO or a mixture thereof.

Catalysts of the invention are prepared by complexing transition metal compounds with the ligands disclosed herein according to known procedures. In principle, any transition metal may be used. Preferably, the transition metal is a Group VIII transition metal. More preferably, the transition metal is rhodium, iridium, ruthenium, nickel, or palladium. Acceptable transition metal compounds are disclosure, for example, in U.S. Pat. Nos. 6,337,406 and 6,037,500, the contents of which are incorporated herein by reference.

Preferably the ligand is complexed with a transition metal compound, such as, [Rh(COD)Cl]₂, [Rh(COD)₂]X, [Ir(COD)Cl]₂, and [Ir(COD)₂]X wherein X is BF₄, ClO₄, SbF₆, or CF₃SO₃.

In a more preferred embodiment, the catalyst can be Ru(RCOO)₂(diphosphine), RuX₂(diphosphine), Ru(methylallyl)₂-(diphosphine) or Ru(aryl group)X₂(diphosphine) wherein X is Cl or Br.

In another aspect, the present invention includes a process for preparation of an asymmetric compound using the catalysts described above. The process includes the step of contacting a substrate capable of forming an asymmetric product by an asymmetric reaction and a catalyst according to the present invention prepared by contacting a transition metal salt, or a complex thereof, and a ligand according to the present invention.

Suitable asymmetric reactions include asymmetric hydrogenation, hydride transfer, allylic alkylation, hydrosilylation, hydroboration, hydrovinylation, hydroformylation, olefin metathesis, hydrocarboxylation, isomerization, cyclopropanation, Diels-Alder reaction, Heck reaction, isomerization, Aldol reaction, Michael addition; epoxidation, kinetic resolution and [m+n] cycloaddition wherein m=3 to 6 and n=2.

Preferably, the asymmetric reaction is hydrogenation and the substrate to be hydrogenated is an ethylenically unsaturated compound, imine, ketone, enamine, enamide, and vinyl ester.

The present invention still further includes a process for preparation of an asymmetric compound including:

contacting a substrate capable of forming an asymmetric product by an asymmetric reaction and a catalyst prepared by a process including: contacting a transition metal salt, or a complex thereof, and a chiral ligand according to the present invention as described herein above.

Two other embodiments of the invention include the following:

(1) a method of catalyzing Michael addition of enones using a copper complex of a ligand according to the present invention, wherein the copper precursor is Cu(OTf)₂, CuI or Cu(CH₃CN)₄(OTf)₂; and

(2) a method of catalyzing hydrovinylation using a Ni complex of a ligand according to the present invention, wherein the Ni precursor is [Ni(allyl)X]₂, [Ni(allyl)X]₂ or Ni(allyl)(phosphine) wherein X is Cl, Br, BAr₄, OTf or SbF₆.

A variety of asymmetric reactions such as hydrogenation, hydride transfer reaction, hydrosilylation, hydroboration, hydrovinylation, hydroformylation, hydrocarboxylation, allylic alkylation, cyclopropanation, Diels-Alder reaction, Aldol reaction, Heck reaction and Michael addition are possible applications for ligand systems derived from this synthon. This approach is especially useful for making compounds having high enantiomeric purity.

The present invention also provides a process for the preparation of 4-halo-4,5-dihydro-3H-4-phospha-cyclohepta[2,1-a;3,4-a′] binaphthalene. The process includes:

contacting di-lithium complex of 2,2′-dimethyl-1,1′-binaphthyl and PX₃ under reaction conditions sufficient to produce the 4-halo-4,5-dihydro-3H-4-phospha-cyclohepta[2,1-a;3,4-a′] binaphthalene; wherein X can be Cl, Br or I.

The present invention further provides a process for the preparation of a chiral bisphosphine ligand, including the step of:

contacting (R) or (S)-4-halo-4,5-dihydro-3H-4-phospha-cyclohepta[2,1-a;3,4-a′]binaphthalene and a reagent, such as, LiA′Li and XMgA′MgX wherein X is Cl or Br; wherein A′ can be —OR²O—, —NH R²NH—, NR′(R)NR′—, —NR′—, ferrocene or a chemical bond; and wherein R² can be an alkylene, arylene or heteroarylene group;

wherein the contacting is carried out under conditions to produce the chiral bisphosphine ligand.

Preferably, A′ is (CH₂)ₙ (n=1-6), arylene, hetereoarylene or ferrocene-di-yl (-CpFeCp-).

The present invention still further provides a process for the preparation of a chiral phospholane having a ferrocene backbone. The process includes:

contacting di-lithium complex of 2,2′-dimethyl-11′-binaphthyl and Cl₂P(CpFeCp)PCl₂ under reaction conditions sufficient to produce the chiral phospholane having a ferrocene backbone.

A chiral phospholane having a ferrocene backbone can thus be prepared by the above process.

The present invention further still provides a process for the preparation of a chiral bisphosphine ligand. The process includes the step of:

contacting, in the presence of a base, (R) or (S)-4-halo-4,5-dihydro-3H-4-phospha-cyclohepta[2,1-a;3,4-a′]-binaphthalene and NH2R′, HOR²OH, NH2-R²NH2 and HNR′(R²)NR′H; wherein R² can be an alkylene, arylene or heteroarylene group; and wherein each R and R′ can independently be alkyl, aryl, alkylaryl, arylalkyl, each of which can be independently substituted with one or more groups, such as, carboxylic acid, alkoxy, hydroxy, alkylthio, thiol or dialkylamino groups.

Representative examples of the ligands according to the present invention include the following, which can be synthesized by a number of pathways, which will become apparent from the following examples.

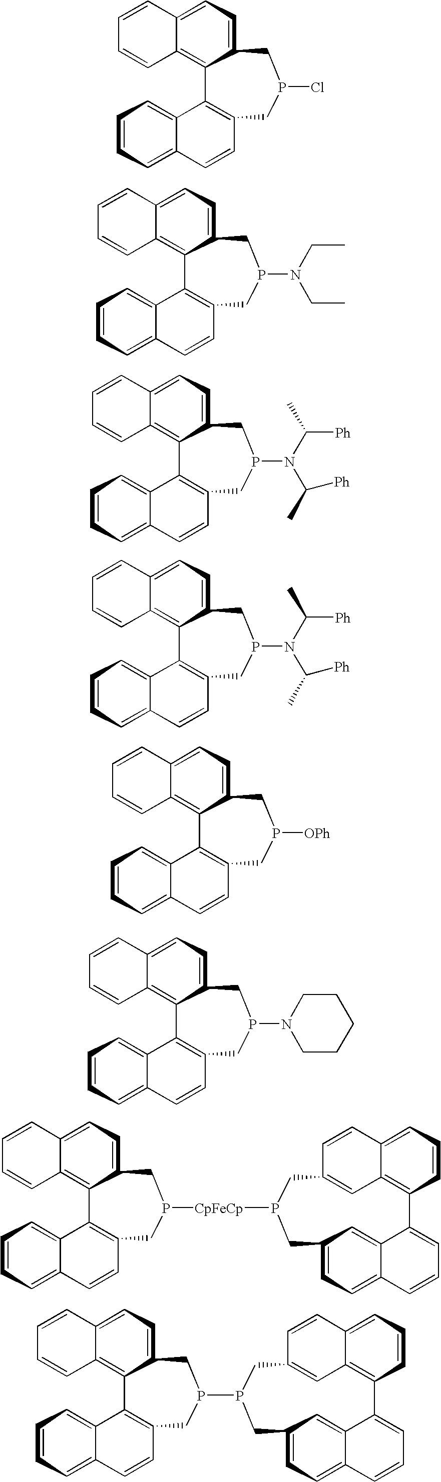

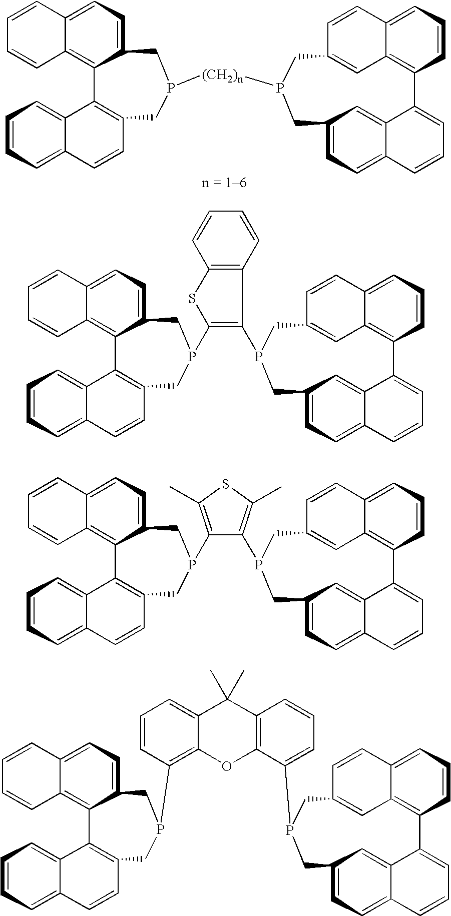

### EXAMPLES

General Procedures:

All reactions and manipulations were performed in a nitrogen-filled glove box or using standard Schlenk techniques. THF and toluene were dried and distilled from sodium-benzophenone ketyl under nitrogen. Methylene chloride was distilled from CaH₂. Methanol was distilled from Mg under nitrogen. (R, R)-BDNPB was made a solution of 10 mg/ml in toluene before use. Column chromatography was performed using EM silica gel 60 (230˜400 mesh). ¹H, ¹³C and ³¹P NMR were recorded on Bruker WP-200, AM-300, and AMX-360 spectrometers. Chemical shifts were reported in ppm down field from tetramethylsilane with the solvent resonance as the internal standard. Optical rotation was obtained on a Perkin-Elmer 241 polarimeter. MS spectra were recorded on a KRATOS mass spectrometer MS 9/50 for LR-EI and HR-EI. GC analysis was carried on Hewlett-Packard 6890 gas chromatography using chiral capillary columns. HPLC analysis was carried on Waters™ 600 chromatography.

Synthesis of 1,2-Bis{(R)-4,5-dihydro-3H-dinaphtho[1,2-c;2′,1′-e]phosphepino}benzene:

(R)-2,2′-bistriflate-1,1′-binaphthyl (2):

To a solution of (R)-BINOL (40.3 g, 140.7 mmol) in 900 mL of CH₂Cl₂ was added pyridine (40 mL) and followed by dropwise addition of triflic anhydride (50.5 mL, 300 mmol) at 0° C. The mixture was stirred at r.t. for 6 h. After removal of the solvent, the residue was diluted with EtOAc (500 mL) and then washed with 5% aqueous HCl (100 mL), saturated NaHCO₃ (100 mL) and brine (100 mL). The organic layer was dried over anhydrous sodium sulfate, concentrated and passed through a silica gel plug (eluted with CH₂Cl₂) to give the (R)-bistriflate (2) (77 g, 99%).

(R)-2,2′-dimethyl-1,1′-binaphthyl (3):

To a solution of (R)-bistriflate (2) (77 g, 140 mmol) and NiCl₂.dppp (3.8 g, 7 mmol) in ether (1000 mL) was added dropwise the methyl magnesium bromide (3.0 M, 280 mL) at 0° C. The reaction mixture was heated to refluxing for 24 h. The reaction was quenched by addition of water (200 mL) slowly at 0° C. and then diluted with 5% aqueous HCl (200 mL). The aqueous layer was extracted with ether (3×100 mL). The combined organic layer was washed with NaHCO₃(100 mL), dried over anhydrous sodium sulfate and concentrated to afford 3 as light yellow color solid (39.2 g, 99%).

Di-lithium TMEDA complex of (S)-2,2′-Dimethyl-1,1′-Binaphthyl:

A solution of n-BuLi in hexane (13.3 ml, 1.6M, 21.3 mmol) was concentrated under vacuum, then it was cooled to 0° C., 10 ml diethyl ether and TMEDA (2.48 g, 21.3 mmol) was added. A solution of (S)-2,2′-Dimethyl-1,1′-Binaphthyl (2 g, 7.09 mmol) in 10 ml ether was added dropwise, under stirring and cooling. The resulting mixture was warmed to r.t., and stirred for 24 hours, then further 4 hours at 0° C. Filtered under N₂, and washed with 3×20 ml hexane.

The di-lithium TMEDA complex of (S)-2,2′-Dimethyl-1,1′-Binaphthyl was obtained as dark red powder (4.35 g, 60% yield).

Ref. Klein, H.; Jackstell, R.; Wiese, K.-D.; Borgmann, C.; Buller, M. Angew. Chem., Int. Ed. 2001, 40, 3408.

Synthesis of key chiral synthon-(S)-4-chloro-4,5-dihydro-3H-4-phospha-cyclohepta[2,1-a;3,4-a′]binaphthalene:

The slurry of di-lithium TMEDA complex of (S)-2,2′-Dimethyl-1,1′-Binaphthyl (4.35 g, 10.62 mmol) in 50 ml hexane, phosphorus trichloride (1.46 g, 10.62 mmol) was added drop-wise slowly at −78° C. Then the reaction system was slowly warmed to r.t., and stirred overnight. The salt was filtered, and crude product was purified through recrystallization from CH₂Cl₂/hexane, the desired key synthon (S)-4-chloro-4,5-dihydro-3H-4-phospha-cyclohepta[2,1-a;3,4-a′]binaphthalene was obtained as a yellow powder, 1.43 g, 40% yield.

¹H-NMR (360 MHz, CD₂Cl₂) δ: 7.92-7.97 (m, 4H, Ar—H), 7.48-7.49 (m, 4H, Ar—H), 7.24 (d, 4H, J=4.74 Hz, Ar—H), 2.70-3.44 (m, 4H, ArCH₂); ³¹P-NMR (146 MHz, CD₂Cl₂) δ: 116.5 ppm.

Synthesis of Chiral Phosphorus Compounds from 4-chloro-4,5-dihydro-3H-4-phospha-cyclohepta[2,1-a;3,4-a′]binaphthalene:

Diethyl amine (37 mg, 0.5 mmol) was added to a solution of key synthon (173 mg, 0.5 mmol) in 40 ml toluene, then followed by triethylamine (51 mg, 0.5 mmol) at −40° C. The reaction solution was stirred for 6 hours and the crude product was purified through recrystallization from CH₂Cl₂/hexane. The desired (S)-Mono-dentate phosphoramidite ligand was obtained as a yellow powder, 173 mg, 72% yield.

¹H-NMR (360 MHz, CD₂C[₂) δ: 7.77-7.86 (m, 4H, Ar—H), 7.45-7.54 (m, 2H, Ar—H), 7.27-7.41 (m, 2H, Ar—H), 7.06-7.19 (m, 4H, Ar—H), 2.84-2.97 (m, 2H, ArCH₂), 2.70-2.81 (m, 2H, ArCH₂), 1.35(q, 4H, —CH₂), 0.91(t, 6H, —CH₃); ³¹P-NMR (146 MHz, CD₂Cl₂) δ: 73.2 ppm.

Phenol (173 mg, 0.5 mmol) was added to a solution of key synthon (173 mg, 0.5 m mol) in 40 ml toluene, then followed by triethylamine (51 mg, 0.5 mmol) at −40° C. The reaction solution was stirred for 6 hrs. the crude product was purified through recrystallization from CH₂Cl₂/hexane, the desired (S)— mono-dentate phosphite ligand was obtained as a yellow powder, 139 mg, 70% yield.

¹H-NMR (360 MHz, CD₂Cl₂) δ: 8.21-8.26 (m, 5H, Ph-H), 6.73-7.76 (m, 12H, Nap-H), 2.76-3.72 (m, 4H, ArCH₂); ³¹P-NMR (146 MHz, CD₂Cl₂) δ: 152.0 ppm.

t-Butylmagnesium chloride in THF (0.5 ml, 1 M, 0.5 mmol) was added dropwise slowly to a solution of key synthon (173 mg, 0.5 mmol) in 20 ml THF at 0° C. The reaction solution was stirred for 6 hours and the crude product was purified through recrystallization from CH₂Cl₂/hexane, the desired (S)— Mono-dentate phosphane ligand was obtained as a yellow powder, 60 mg, 57% yield.

¹H-NMR (360 MHz, CD₂Cl₂) δ: 7.84-7.96 (m, 4H, Ar—H), 7.55-7.64 (m, 2H, Ar—H), 7.39-7.47 (m, 2H, Ar—H), 7.06-7.28 (m, 4H, Ar—H), 2.58-2.88 (m, 4H, ArCH₂), 1.05(d, J=11.7 Hz, 9H, t-Bu); ³¹P-NMR (146 MHz, CD₂Cl₂) δ: 29.6 ppm.

(1R, 2R)-(+)-1,2-Diamino-cyclohexane (29 mg, 0.25 m mol) was added to a solution of key synthon (173 mg, 0.5 m mol) in 40 ml toluene, then followed by triethylamine (51 mg, 0.5 mmol) at −40° C. The reaction solution was stirred for 6 hours and the crude product was purified through recrystallization from CH₂Cl₂/hexane. The desired (S,R,R,S)-bidentate phosphoramidite ligand was obtained as a yellow powder, 116 mg, 63% yield.

¹H-NMR (360 MHz, CD₂Cl₂) δ: 7.73-7.87 (m, 8H, Ar—H), 7.40-7.46 (m, 8H, Ar—H), 6.91-7.35 (m, 8H, Ar—H), 1.92-3.28 (m, 8H, ArCH₂), 1.10-1.31(m, 8H, Cyclo-Hexane); ³¹P-NMR (146 MHz, CD₂Cl₂) δ: 59.5 ppm.

Note that the (S,S,S,S)— bidentate phosphoramidite ligand can be made in same way.

1,2-bis{(S)-4,5-dihydro-3H-binaphthol[1,2-c:2′,1′-e]phosphepino} ethane:

The slurry of di-lithium TMEDA complex of (S)-2,2′-Dimethyl-1,1′-Binaphthyl (410 mg, 1 mmol) in 50 ml hexane, 1,2′-bis(dichlorophos-phine) ethane (116 mg, 0.5 mmol) was added dropwise solely at −78° C. Then the reaction system was slowly warmed to r.t., and stirred overnight. The salt was filtered, and crude product was purified through recrystallization from CH₂Cl₂/hexane, the desired (S,S)-1,2-bis{(S)-4,5-dihydro-3H-binaphthol[1,2-c:2′,1′-e]phosphepino}ethane was obtained as yellow powder, 358 mg, 55% yield.

¹H-NMR (360 MHz, CD₂Cl₂) δ: 7.80-7.88 (m, 8H, Ar—H), 7.30-7.33 (m, 8H, Ar—H), 7.12 (d, J=4.5 Hz, 8H, Ar—H), 2.10-2.86 (m, 8H, ArCH₂), 1.48-1.62(m, 2H, —CH₂), 1.24-1.38(m, 2H, —CH₂); ³¹P-NMR (146 MHz, CD₂Cl₂) δ: 9.06 ppm.

1,1′-Bis(dichlorophosphino)-Ferrocene Di-Lithium TMEDA Complex of Ferrocene:

To a solution of n-BuLi (25 ml, 2.5M, 62.5 m mol) and TMEDA (9.5 ml, 62.5 m mol) in 10 ml hexane, solution of Ferrocene (4.65 g, 25 m mol) in 200 ml hexane was added dropwise in the period of 0.5 hour at r.t., the reaction system was stirred for 16 hours at r.t., filtered under N₂, and washed with 3×20 ml hexane. The di-lithium TMEDA complex of ferrocene was obtained as orange powder (4.40 g, 70% yield).

1,1′-Bis(dichlorophosphino)-Ferrocene:

A solution of di-lithium TMEDA complex of Ferrocene (314 mg, 1 mmol) in 5 ml ether was treated with bis(diethylamino)chlorophosphine (0.46 mL, 2.2 mmol) at 0° C., the reaction system was warmed to r.t., and stirred for 2 hours. Then 10 ml hydrochloride ether solution (1M, 10 mmol) was added solely under cooling to 0° C., warmed to r.t., and stirred for 2 hours. The precipitate was filtered off under N₂, the solid was washed with 2×10 ml ether, the combined ether solution was concentrated, and recrystallized from 3 ml pentane. 1,1′-Bis(dichlorophosphino)-Ferrocene was obtained as light brown solid.(290 mg, 75% yield). ³¹P-NMR (146 MHz, CD₂Cl₂) δ: 163.9 ppm. (Ref. I. E. Nifantev, and A. A. Boricenko Phosphours, Sulfur, and Silicon, 1992, 68, 99).

Synthesis of (S,S)-Ferrocene Binaphane (f-Binaphane)

To a slurry of di-lithium TMEDA complex of (S)-2,2′-Dimethyl-1,1′-Binaphthyl (615 mg, 1.5 mmol) 15 ml THF, the solution of 1,1′-Bis(dichlorophosphino)-Ferrocene (290 mg, 0.75 mmol) in 5 ml THF was added dropwise at −78° C. under nitrogen. The mixture was kept stirring overnight at room temperature. The reaction was quenched with 10 ml H₂O, the solvent was removed via vacuum and 20 ml CH₂Cl₂ was added, the organic layer was separated and washed with 3×20 ml H₂O, then dried over sodium sulfate. The organic phase was filtered through a silica gel plug to give the fairly pure product.

Further purification by recrystallization from 1 mL CH₂Cl₂/10 mL Hexane afforded (S,S)-Ferrocene Binaphane as orange powder (489 mg, 80.8% yield).

¹H-NMR (360 MHz, CD₂Cl₂) δ: 8.07-7.99 (m, 6H, Ar—H), 7.86 (d, 2H, J=8.34 Hz, Ar—H), 7.79 (d, 2H, J=8, 31 Hz), 7.53-7.50 (m, 14H, Ar—H), 7.31-7.28 (m, 8H, Ar—H), 7.06 (d, 2H, J=8.37 Hz), 4.49 (s, 2H, Cp-H), 4.45 (s, 2H, Cp-H), 4.26 (s, 2H, Cp-H), 3.56 (s, 2H, Cp-H), 3.10-3.06 (m, 2H, ArCH₂), 2.82-2.71 (m, 4H, ArCH₂), 2.63-2.59 (m, 2H, ArCH₂) ppm; ³¹P NMR (146 MHz, CD₂Cl₂) 6-1.30 ppm.

General Procedure for Catalytic Asymmetric Hydrogenation of Enamides:

In a glove box, the Rh-phosphine complex was made in situ by mixing Rh(COD)₂ PF₆ (3.7 mg, 0.008 mmol) and a chiral bisphosphine (0.8 mL of 10 mg/mL ligand in toluene, 0.012 mmol) in 19.2 mL of CH₂Cl₂. The mixture was stirred for 30 min. Then 2.5 mL of this solution was transferred to a 10 mL vial with an enamide substrate (0.1 mmol). The hydrogenation was performed at r.t. under 20 psi of hydrogen pressure for 24 h. The hydrogen was released carefully and the reaction mixture was passed through a silica gel plug eluted with EtOAc.

The enantiomeric excess was measured by GC or HPLC using a chiral GC or HPLC column without further purification. The absolute configuration of products was determined by comparing the sign of optical rotation with the reported data.

Asymmetric Hydrogenation:

TABLE I
Asymmetric Hydrogenation

| | Substrate | | |
|---|---|---|---|
| Ligand | 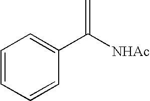 | 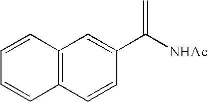 | 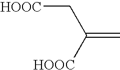 |
| 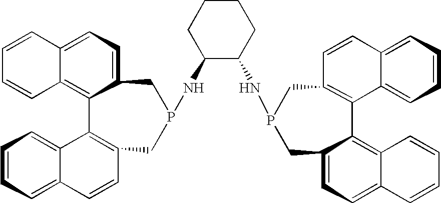 | 44% ee | 77% ee | 69% ee |
| 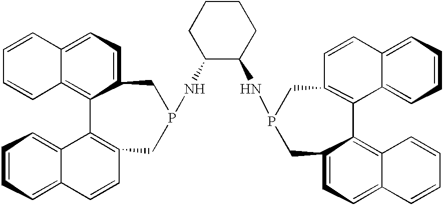 | 71% ee | 90% ee | 86% ee |

| Ligand | 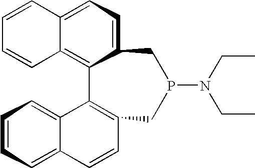 | 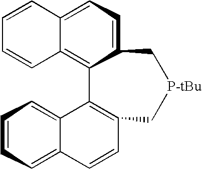 | 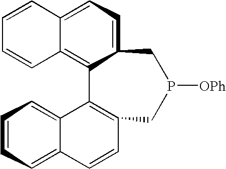 |
|---|---|---|---|
| 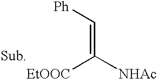 | 59% ee | 56% ee | 6% ee |

The reaction was carried out at room temperature under an initial hydrogen pressure of 40 psi for 24 h. The catalyst was made in situ by stirring a solution of Rh(COD)₂SbF₆ and chiral ligand in MeOH. The reaction proceeded in quantitative yield.

Enantiomeric excesses were determined by chiral GC with a Supelco chiral select 1000 column, or gamma dex 225 column.

TABLE II
Asymmetric Hydrogenation

| | Substrate | | |
|---|---|---|---|
| Ligand | 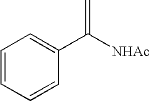 | 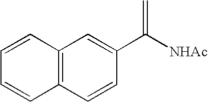 | 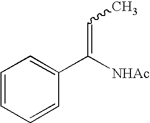 |
| 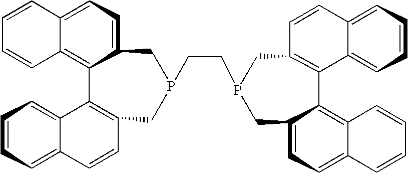 | 77% ee | 94% ee | 98% ee |

| Ligand | 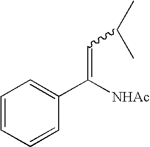 | 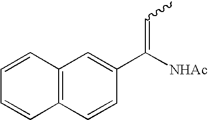 |
|---|---|---|
| 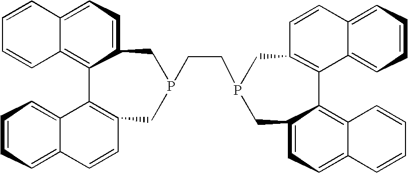 | 98% ee | >99% ee |
| Ligand | 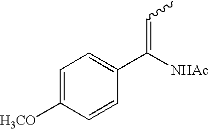 | 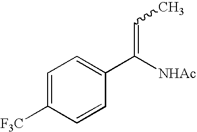 |
| 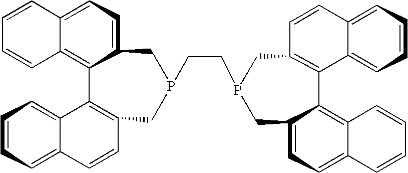 | 98% ee | 93% ee |

The reaction was carried out at room temperature under an initial hydrogen pressure of 40 psi for 24 h. The catalyst was made in situ by stirring a solution of Rh(NBD)₂SbF₆ and a chiral ligand in MeOH. [substrate(0.5 mmol)]: [Rh]: ligand=100:1:1.1. The reaction proceeded in quantitative yield. Enantiomeric excesses were determined by chiral GC with a Supelco chiral select 1000 column, or Chiral HPLC with Regis (S,S)-Whelk-01 column.

The present invention has been described with particular reference to the preferred embodiments. It should be understood that the foregoing descriptions and examples are only illustrative of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A chiral ligand selected from the group consisting of compounds represented by the following formulas and its enantiomer: 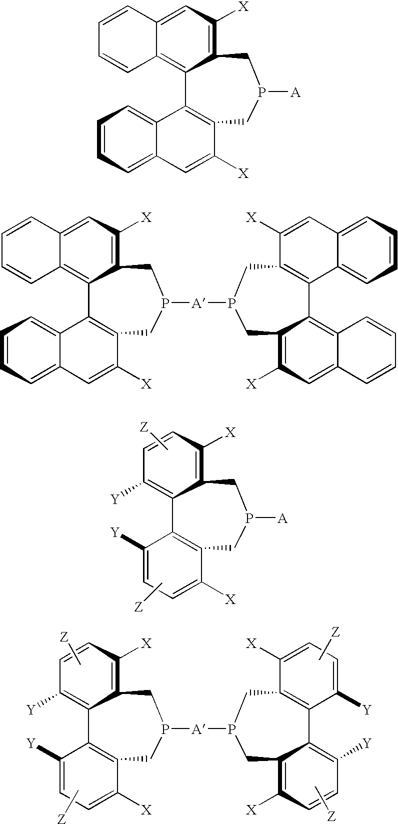
wherein each R and R′ is independently selected from the group consisting of: alkyl, aryl, alkylaryl, arylalkyl, each of which can be independently substituted with one or more groups selected from the group consisting of: carboxylic acid, alkoxy, hydroxy, alkylthio, thiol, and dialkylamino groups;
wherein each X is independently selected from the group consisting of: hydrogen, halide, alkyl, aryl, alkylaryl, arylalkyl, alkoxy, silane, carboxylate and amide;
wherein each Y is independently selected from the group consisting of: alkyl, aryl, alkylaryl, arylalkyl, alkoxy, carboxylic, amide and a heterocyclic compound;
wherein each Z is independently selected from the group consisting of: hydrogen, alkyl, aryl, alkylaryl, arylalkyl, alkoxy, amide, carboxylate, and a heterocyclic compound;
wherein A is selected from the group consisting of: halide, alkoxy, phenoxide, amide and substituted amide;
wherein A′ is selected from the group consisting of:, —OR²O—, —NHR²NH—, NR′(R²)NR′—, —NR′—, ferrocene and a chemical bond; and
wherein R² is selected from the group consisting of: an alkylene, arylene and heteroarylene group.

2. A chiral ligand according to claim 1, wherein each R and R′ group comprises a stereogenic center.

3. A chiral ligand according to claim 1, selected from the group consisting of compounds represented by the following formulas and its enantiomer:

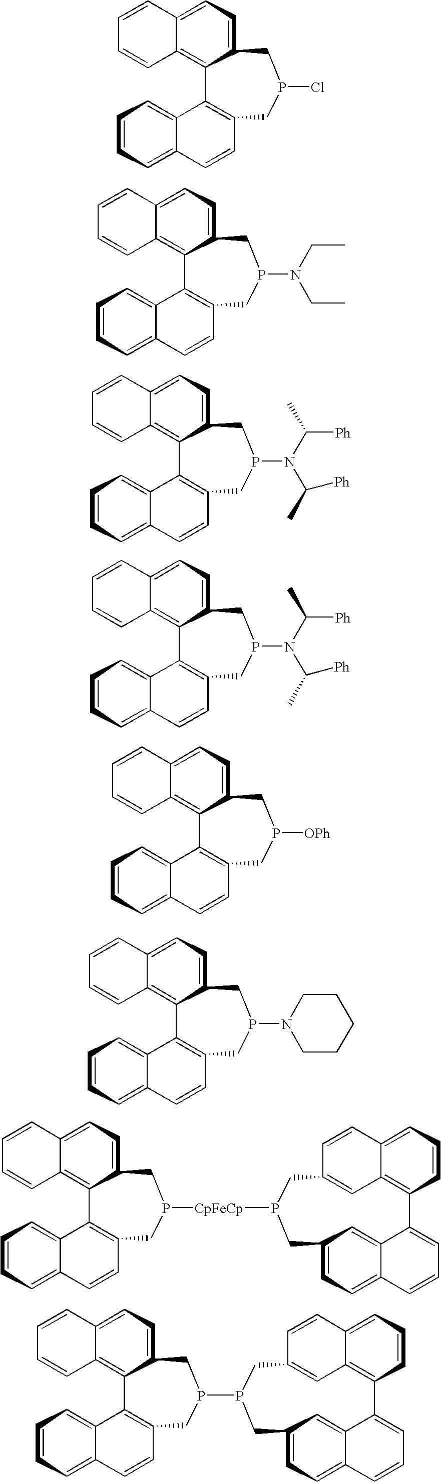

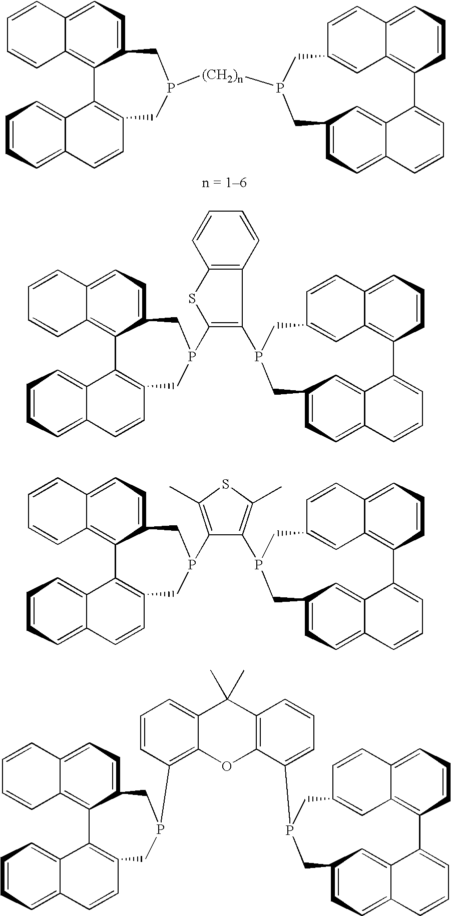

4. A catalyst prepared by a process comprising:
contacting a transition metal salt, or a complex thereof, and a chiral ligand selected from the group consisting of compounds represented by the following formulas and its enantiomer: 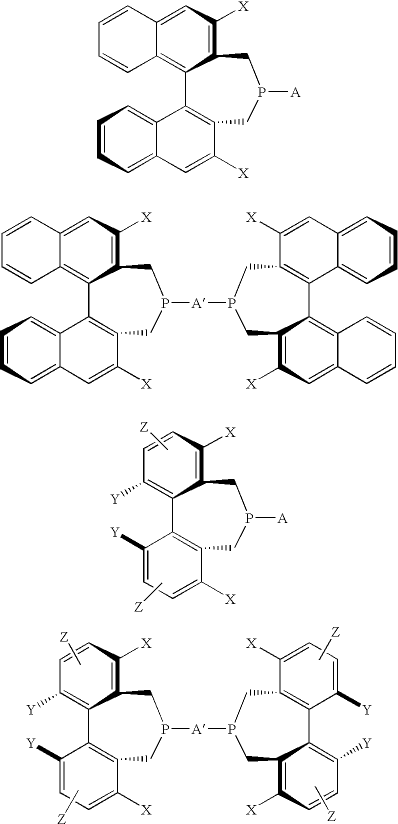
wherein each R and R′ is independently selected from the group consisting of: alkyl, aryl, alkylaryl, arylalkyl, each of which can be independently substituted with one or more groups selected from the group consisting of: carboxylic acid, alkoxy, hydroxy, alkylthio, thiol, and dialkylamino groups;
wherein each X is independently selected from the group consisting of: hydrogen, halide, alkyl, aryl, alkylaryl, arylalkyl, alkoxy, silane, carboxylate and amide;
wherein each Y is independently selected from the group consisting of: alkyl, aryl, alkylaryl, arylalkyl, alkoxy, carboxylic, amide and a heterocyclic compound;
wherein each Z is independently selected from the group consisting of: hydrogen, alkyl, aryl, alkylaryl, arylalkyl, alkoxy, amide, carboxylate, and a heterocyclic compound;
wherein A is selected from the group consisting of: halide, alkoxy, phenoxide, amide and substituted amide;
wherein A′ is selected from the group consisting of:, —OR²O—, —NH R²NH—, NR′(R²)NR′—, —NR′—, ferrocene and a chemical bond; and wherein R² is selected from the group consisting of: an alkylene, arylene and heteroarylene group;
wherein said contacting is carried out under conditions to produce said catalyst.

5. The catalyst of claim 4, wherein said catalyst is a non-racemic mixture of enantiomers.

6. The catalyst of claim 4, wherein said catalyst is one of the enantiomers.

7. The catalyst of claim 4, wherein said transition metal is selected from the group consisting of: Ag, Pt, Pd, Rh, Ru, Ir, Cu, Ni, Mo, Ti, V, Re and Mn.

8. The catalyst of claim 7, wherein said transition metal is selected from the group consisting of: Rh, Ir, Ru, Cu, and Pd.

9. The catalyst of claim 4, wherein said transition metal salt, or complex thereof, is selected from the group consisting of: AgX; Ag(OTf); Ag(OTf)₂; AgOAc; PtCl₂; H₂PtCl₄; Pd₂(DBA)₃; Pd(OAc)₂; PdCl₂(RCN)₂; (Pd(allyl)Cl)₂; Pd(PR₃)₄; (Rh(NBD)₂)X; (Rh (NBD)Cl)₂; (Rh(COD)Cl)₂; (Rh(COD)₂)X; Rh(acac)(CO)₂; Rh(ethylene)₂(acac); (Rh(ethylene)₂Cl)₂; RhCl(PPh₃)₃; Rh(CO)₂Cl₂; RuHX(L)₂(diphosphine), RuX₂(L)₂ (diphosphine), Ru(arene)X₂(diphosphine), Ru(aryl group)X₂; Ru(RCOO)₂(diphosphine); Ru(methallyl)₂(diphosphine); Ru(aryl group)X₂(PPh₃)₃; Ru(COD)(COT); Ru(COD)(COT)X; RuX₂(cymen); Ru(COD)ₙ; Ru(aryl group)X₂(diphosphine); RuCl₂(COD); (Ru(COD)₂)X; RuX₂(diphosphine); RUCl₂(═CHR)(PR₁₃)₂; Ru(ArH)Cl₂; Ru(COD)(methallyl)₂; (Ir (NBD)₂Cl)₂; (Ir(NBD)₂)X; (Ir(COD)₂Cl)₂; (Ir(COD)₂)X; CuX (NCCH₃) 4; Cu(OTf); Cu(OTf)₂; Cu(Ar)X; CuX; Ni(acac)₂; NiX₂; (Ni(allyl)X)₂; Ni(COD)₂; MoO₂(acac)₂; Ti(OiPr)₄; VO(acac)₂; MeReO₃; MnX₂ and Mn(acac)₂; wherein each R and R′ is independently selected from the group consisting of: alkyl or aryl; Ar is an aryl group; and X is a counteranion.

10. The catalyst of claim 9, wherein L is a solvent and wherein said counteranion X is selected from the group consisting of: halogen, BF₄, B(Ar)₄ wherein Ar is fluorophenyl or 3,5-di-trifluoromethyl-1-phenyl, ClO₄, SbF₆, PF₆, CF₃SO₃, RCOO and a mixture thereof.

11. The catalyst of claim 4, prepared in situ or as an isolated compound.

12. A process for preparation of an asymmetric compound comprising the step of:
contacting a substrate capable of forming an asymmetric product by an asymmetric reaction and a catalyst under conditions to produce said asymmetric compound; wherein said catalyst is prepared by a process comprising contacting a transition metal salt, or a complex thereof, and a chiral ligand selected from the group consisting of compounds represented by the following formulas and its enantiomer: 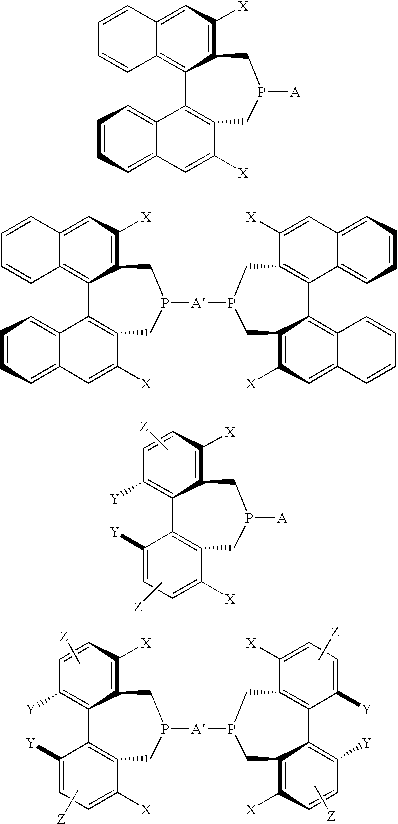
wherein each R and R′ is independently selected from the group consisting of: alkyl, aryl, alkylaryl, arylalkyl, each of which can be independently substituted with one or more groups selected from the group consisting of: carboxylic acid, alkoxy, hydroxy, alkylthio, thiol, and dialkylamino groups;
wherein each X is independently selected from the group consisting of: hydrogen, halide, alkyl, aryl, alkylaryl, arylalkyl, alkoxy, silane, carboxylate and amide;
wherein each Y is independently selected from the group consisting of: alkyl, aryl, alkylaryl, arylalkyl, alkoxy, carboxylic, amide and a heterocyclic compound;
wherein each Z is independently selected from the group consisting of: hydrogen, alkyl, aryl, alkylaryl, arylalkyl, alkoxy, amide, carboxylate, and a heterocyclic compound;
wherein A is selected from the group consisting of: halide, alkoxy, phenoxide, amide and substituted amide;
wherein A′ is selected from the group consisting of:, —OR²O—, —NH R²NH—, NR′(R²)NR′—, —NR′—, ferrocene and a chemical bond; and
wherein R² is selected from the group consisting of: an alkylene, arylene and heteroarylene group.

13. The process of claim 12, wherein said catalyst is a non-racemic mixture of enantiomers.

14. The process of claim 12, wherein said catalyst is one of the enantiomers.

15. The process of claim 12, wherein said transition metal is selected from the group consisting of: Ag, Pt, Pd, Rh, Ru, Ir, Cu, Ni, Mo, Ti, V, Re and Mn.

16. The process of claim 15, wherein said transition metal is selected from the group consisting of: Rh, Ir, Ru, Cu, and Pd.

17. The process of claim 12, wherein said transition metal salt, or complex thereof, is selected from the group consisting of: AgX; Ag(OTf); Ag(OTf)₂; AgOAc; PtCl₂; H₂PtCl₄; Pd₂(DBA)₃; Pd(OAc)₂; PdCl₂(RCN)₂; (Pd(allyl)Cl)₂; Pd(PR₃)₄; (Rh(NBD)₂)X; (Rh (NBD)Cl)₂; (Rh(COD)Cl)₂; (Rh(COD)₂)X; Rh(acac)(CO)₂; Rh(ethylene)₂(acac); (Rh(ethylene)₂Cl)₂; RhCl(PPh₃)₃; Rh(CO)₂Cl₂; RuHX(L)₂(diphosphine), RuX₂(L)₂ (diphosphine), Ru(arene)X₂(diphosphine), Ru(aryl group)X₂; Ru(RCOO)₂(diphosphine); Ru(methallyl)₂(diphosphine); Ru(aryl group)X₂(PPh₃)₃; Ru(COD)(COT); Ru(COD)(COT)X; RuX₂(cymen); Ru(COD)ₙ; Ru(aryl group)X₂(diphosphine); RuCl₂(COD); (Ru(COD)₂)X; RuX₂(diphosphine); RuCl₂(═CHR)(PR₁₃)₂; Ru(ArH)Cl₂; Ru(COD)(methallyl)₂; (Ir (NBD)₂Cl)₂; (Ir(NBD)₂)X; (Ir(COD)₂Cl)₂; (Ir(COD)₂)X; CuX (NCCH₃)₄; Cu(OTf); Cu(OTf)₂; Cu(Ar)X; CuX; Ni(acac)₂; NiX₂; (Ni(allyl)X)₂; Ni(COD)₂; MoO₂(acac)₂; Ti(OiPr)₄; VO(acac)₂; MeReO₃; MnX₂ and Mn(acac)₂; wherein each R and R′ is independently selected from the group consisting of: alkyl or aryl; Ar is an aryl group; and X is a counteranion.

18. The process of claim 17, wherein L is a solvent and wherein said counteranion X is selected from the group consisting of: halogen, BF₄, B(Ar)₄ wherein Ar is fluorophenyl or 3,5-di-trifluoromethyl-1-phenyl, ClO₄, SbF₆, PF₆, CF₃SO₃, RCOO and a mixture thereof.

19. The process of claim 12, wherein said transition metal salt, or complex thereof, is selected from the group consisting of:
[Rh (COD)Cl]₂, [Rh(COD)₂]X (X=BF₄, ClO₄, SbF₆ or CF₃SO₃), (Ir(COD)Cl]₂, [Ir(COD)₂]X (X=BF₄, ClO₄, SbF₆ or CF₃SO₃), Ru(RCOO)₂(diphosphine), RuX₂(diphosphine) (X=Cl or Br), Ru(methylallyl)₂(diphosphine) and Ru(aryl group)X₂(diphosphine).

20. The process of claim 12, wherein said asymmetric reaction is selected from the group consisting of: hydrogenation, hydride transfer, allylic alkylation, hydrosilylation, hydroboration, hydrovinylation, hydroformylation, olefin metathesis, hydrocarboxylation, isomerization, cyclopropanation, Diels-Alder reaction, Heck reaction, isomerization, Aldol reaction, Michael addition; epoxidation, kinetic resolution and [m+n] cycloaddition wherein m=3 to 6 and n=2.

21. The process of claim 20, wherein said asymmetric reaction is hydrogenation and said substrate is selected from the group consisting of: imine, ketone, ethylenically unsaturated compound, enamine, enamide, enone and vinyl ester.

22. The process of claim 21, wherein said asymmetric reaction is an iridium, ruthenium, rhenium or palladium-catalyzed hydrogenation of an olefin, imine, enamide or ketone.

23. The process of claim 20, wherein said asymmetric reaction is copper-catalyzed Michael addition and said substrate is selected from the group consisting of: imine, ketone, ethylenically unsaturated compound, enamine, enamide, enone and vinyl ester.

24. The process of claim 23, wherein said catalyst is prepared from Cu(OTf)₂, CuI or Cu(CH₃CN)₄(OTf)₂.

25. The process of claim 20, wherein said asymmetric reaction is nickel-catalyzed hydrovinylation and said substrate is selected from the group consisting of: imine, ketone, ethylenically unsaturated compound, enamine, enamide, enone and vinyl ester.

26. The process of claim 25, wherein said catalyst is prepared from [Ni(allyl)Cl]₂, [Ni(allyl)Br]₂ or Ni(allyl)(phosphine).

27. (R) or (S)-4-halo-4,5-dihydro-3H-4-phospha-cyclohepta[2,1-a;3,4-a′] binaphthalene, wherein the halogen is selected from the group consisting of Cl, Br and 1.

28. A process for preparing 4-halo-4,5-dihydro-3H-4-phospha-cyclohepta[2,1-a;3,4-a′] binaphthalene comprising:
contacting di-lithium complex of 2,2′-dimethyl-1,1′-binaphthyl and PX₃ under reaction conditions sufficient to produce said 4-halo-4,5-dihydro-3H-4-phospha-cyclohepta[2,1-a;3,4-a′] binaphthalene; wherein X is selected from the group consisting of: Cl, Br and 1.

29. A process for preparing a chiral bisphosphine ligand, comprising the step of:
contacting (R) or (S)-4-halo-4,5-dihydro-3H-4-phospha-cyclohepta[2,1-a;3,4-a′]binaphthalene and a reagent selected from the group consisting of: LiA′Li and XMgA′MgX wherein X is Cl or Br; wherein A′ is selected from the group consisting of: —OR²O—, —NH R²NH—, NR′(R)NR′—, —NR′—, ferrocene and a chemical bond; and wherein R² is selected from the group consisting of: an alkylene, arylene and heteroarylene group;
wherein said contacting is carried out under conditions to produce said chiral bisphosphine ligand.

30. The process of claim 29, wherein A′ is selected from the group consisting of: (CH₂)ₙ (n=1-6), arylene, hetereoarylene and ferrocene-di-yl (-CpFeCp-).

31. A process of preparing a chiral phospholane having a ferrocene backbone, said process comprising:
contacting di-lithium complex of 2,2′-dimethyl-1,1′-binaphthyl and Cl₂P(CpFeCp)PCl₂ under reaction conditions sufficient to produce said chiral phospholane having a ferrocene backbone.

32. A chiral phospholane having a ferrocene backbone prepared by the process of claim 31.

33. A process of preparing a chiral bisphosphine ligand comprising the step of:
contacting, in the presence of a base, (R) or (S)-4-halo-4,5-dihydro-3H-4-phospha-cyclohepta[2,1-a;3,4-a′]-binaphthalene and NH2R′, HOR²OH, NH2-R²NH2 and HNR′(R²)NR′H; wherein R² is selected from the group consisting of: an alkylene, arylene and heteroarylene group; and wherein each R and R′ is independently selected from the group consisting of: alkyl, aryl, alkylaryl, arylalkyl, each of which can be independently substituted with one or more groups selected from the group consisting of: carboxylic acid, alkoxy, hydroxy, alkylthio, thiol, and dialkylamino groups.
